(19) United States
(12) Patent Application Publication
(10) Pub. No.: US 2025/0307037 A1
(43) Pub. Date: Oct. 2, 2025

(54) DECLARATIVE QUERY SCHEMA-BASED APPLICATION PROGRAMMING INTERFACE

(71) Applicant: INTUIT INC., Mountain View, CA (US)

(72) Inventors: Ashpak Salim SHAIKH, San Diego, CA (US); Carlo Feliciano N. AUREUS, Laguna Niguel, CA (US); Kyle Jacob MOORE, Scottsburg, IN (US); Ankush Arun KAWANPURE, Fallbrook, CA (US); Sumanth MOPARTHY, San Diego, CA (US); Brea Anne HYLAN, Ramona, CA (US); Varadarajan SRIRAM, San Diego, CA (US)

(21) Appl. No.: 18/622,276

(22) Filed: Mar. 29, 2024

(51) Int. Cl. G06F 9/54; G06F 16/25

(52) U.S. Cl. CPC G06F 9/541; G06F 16/252

(57) ABSTRACT

Aspects of the present disclosure relate to application programming interface (API) generation. Embodiments include constructing a query schema for a computing environment. Embodiments further include constructing an orchestrator for the query schema and the computing environment, wherein: the orchestrator is written in a domain specific language associated with the computing environment; and the orchestrator is configured to interact with the query schema in order to determine responses to requests received via an API. Embodiments further provide that information is extracted from the query schema based on a function within the orchestrator including logic that references the query schema. Embodiments further include exposing, by a container service of the computing environment, the API based on the query schema and the orchestrator. Embodiments further provide for the container service to automatically update the API based on receiving and decompressing an additional query schema or an additional orchestrator.

### INTRODUCTION

Aspects of the present disclosure relate to techniques for generating application programming interfaces (APIs). In particular, techniques described herein involve using a container service to expose an API by executing an orchestrator that is configured to interact with a query schema in order to determine responses to requests received via the API.

### BACKGROUND

APIs offer a way for multiple software applications to communicate with each other. A growing number of people, businesses, and organizations around the world utilize APIs to perform complex tasks involving a wide variety of data sources. For example, an API may provide an interface between a software application and a large database, allowing a user of the software application to locate and use specific information from the database.

In the process of creating an API, a particular query schema may be chosen to retrieve data from a data source. This query schema may be chosen, for example, because the data source is configured for use with that schema. However, the query schema may not be configured for use in the user's computing environment. For instance, the query schema may be written in a different language than the language used by the computing environment. In such cases, the computing environment will be unable to request and receive data from the data source via the query schema. As a result of this technical incompatibility, users may have to resort to using a different query schema or a different computing environment. This may result in a suboptimal usage of computing resources, since the most efficient computing environment and the most efficient query schema may not be configured for use with each other.

Thus, there is a need in the art for improved techniques of generating APIs.

### BRIEF SUMMARY

Certain embodiments provide a method of generating APIs. The method generally includes: constructing a query schema for a computing environment; constructing an orchestrator for the query schema and the computing environment, wherein: the orchestrator is written in a domain specific language associated with the computing environment; and the orchestrator is configured to interact with the query schema in order to determine responses to requests received via an API; and exposing, by a container service of the computing environment, the API based on the query schema and the orchestrator.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of computing components related to generating APIs.

FIG. 2 depicts an example of an orchestrator, a query schema, and a configuration file used to generate APIs.

FIG. 3 depicts example operations related to generating APIs.

FIG. 4 depicts an example of a processing system for generating APIs.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for generating application programming interfaces (APIs).

According to certain embodiments, a query schema is constructed for use in a computing environment. The query schema may allow for the retrieval of data from one or more large data sources. For example, the query schema may be written in a declarative query language such as GraphQL. Declarative query languages allow users of an API to request data in a manner that focuses on a desired result of a query, as opposed to imperative query languages, which focus on how to perform a query. The query schema may be configured for use with one or more data sources. Also, one or more data sources may be configured for use with the query schema or the query language (i.e., the data source is specifically designed for use with the query schema and/or query language). The query language of the query schema may be a language with which a user's computing environment is not configured to interact. For example, a software application used by a user may be written in a first language, and the query schema may be written in a second language that is unable to directly interact with the first language.

In some embodiments, to address the native incompatibility between the software application and the query schema, an orchestrator may be constructed for the query schema and the computing environment. An orchestrator is generally an executable file that, when executed, extracts information from the query schema based on a request from a user of a computing environment. A request from a user of the computing environment may comprise an indication of a function within the orchestrator that should be called in order to extract desired information. Based on this indication, the function within the orchestrator may be called, and logic within the orchestrator may extract data from the query schema. This orchestrator function may be linked to or otherwise reference the query schema in a way that allows the orchestrator to extract data from the query schema, such as information within a particular location inside a data source that is referenced by a node of the query schema (e.g., when the node of the query schema is called, the node returns the information). Thus, in response to receiving the request, the orchestrator may return the requested information to the user from the data source by using the query schema.

Some embodiments provide that the orchestrator is written in a domain specific language. Domain specific languages are generally programming languages that are configured for completing a specific type of task. For example, the domain specific language of the orchestrator may be configured for extracting information from query schemas based on queries. The domain specific language of the orchestrator may be a declarative language.

In certain embodiments, the query schema is constructed in a compressed file format, such as a zip file. Certain embodiments provide that the orchestrator is constructed in a compressed file format. In embodiments where declarative languages are used to construct the orchestrator and query schema files, the orchestrator and query schema files may be dynamically updated in a container service without restarting the computing environment.

According to some embodiments, a container service (e.g., a program configured to receive and execute files) is configured to process one or more query schemas and one or more orchestrators. In certain embodiments, the container service may decompress query schemas and orchestrators from compressed files. The container service may execute an orchestrator (e.g., which may comprise an executable file) and expose an API including functions that, when invoked, cause the orchestrator to interact with a data source based on a query schema. Exposing an API may comprise allowing users to request and receive information from the data source (e.g., by accessing, retrieving, and/or otherwise interacting with data that is referenced by or linked to the query schema). Furthermore, multiple orchestrators may be connected in either series or parallel to multiple query schemas, giving users extensive flexibility to create complex APIs that include a multitude of nodes.

Certain embodiments provide that one or more orchestrators contain API logic for implementing the API based on the query schema. For example, API logic may include commands that users may invoke to query information via the API. Thus, a container service may implement an API by executing the orchestrator(s). Alternate embodiments provide that the API logic is written separately from the orchestrator(s) (e.g., within the container service itself), and that upon execution of the orchestrator(s), the logic of the orchestrator(s) is incorporated into the API logic. Thus, in such embodiments, by executing the orchestrators, the container service incorporates the orchestrator logic into the API.

In some embodiments, configuration files may be provided to the container service. Configuration files are generally files other than query schema files and orchestrator files that are provided to the container service. Configuration files may be constructed in a compressed file format such as a zip file. An orchestrator may be configured to extract configuration information from the configuration files in order to configure the API. As an example, the configuration files may contain a reference to a data source that allows the API to extract information from the data source and/or provide extracted information to the data source.

Some embodiments provide that errors in query schemas, orchestrators, and/or configuration files may be detected. Errors may comprise errors in the connection between a query schema and an orchestrator. For example, an orchestrator may contain an incorrect reference to a location within a query schema (i.e., the orchestrator is unable to actually reference the query schema based on errors in the code of the orchestrator). Based on this detected error, the orchestrator may not be executed, and an error message may be generated. Tools used to detect such errors include parse trees and abstract syntax trees. For example, tools for detecting errors may be incorporated into a plugin that is built around the orchestrator file, and this plugin may detect the errors either before or after the code is executed.

Embodiments of the present disclosure provide numerous technical and practical effects and benefits. For instance, teachings of the present disclosure allow for using a query schema in a computing environment that is not natively configured for using the query schema. Such usage has the practical benefit of allowing users greater flexibility and convenience in using an API. For example, embodiments of the present disclosure allow users to run queries based on several different query schemas within a single computing environment regardless of whether the computing environment is natively configured to interact with the query schemas. In addition to providing greater convenience and flexibility to users, teachings of the present disclosure conserve processor resources. For example, if users are unable to run queries of multiple schemas from within a single computing environment at the same time, the users may have to use multiple computing environments, expending processing resources that would otherwise be conserved by only using a single computing environment. Also, teachings of the present disclosure allow for using the most efficient query schema for a data source with the most efficient user environment even when the user environment is not natively configured to interact with the query schema. Generally, techniques described herein overcome the technical problem of native incompatibility between a computing environment and a query schema associated with a data source through the use of an orchestrator that is executed by a container service to expose an API based on the query schema, enabling applications in the computing environment to efficiently access data in the data source via API calls.

Additionally, by providing for an API that is built based on declarative language based query schemas and declarative domain specific language resolvers that are each provided to a container service, teachings of the present disclosure allow for APIs that may be updated without requiring recompilation of the entire API code (i.e., updates may be made without restarting the system). For instance, a new query schema and associated orchestrator may be provided to the container service, and the container service may extract the files and execute the orchestrator, which may interact with the query schema to respond to queries. Such extraction and execution by the container service does not require recompiling the entire API code, as opposed to conventional API generation techniques which use a single file for containing the entire API logic (including the extraction logic). Thus, teachings of the present disclosure allow for seamless additions and updates to APIs in a manner that was not possible with prior techniques.

### Example Components Related to Generating APIs

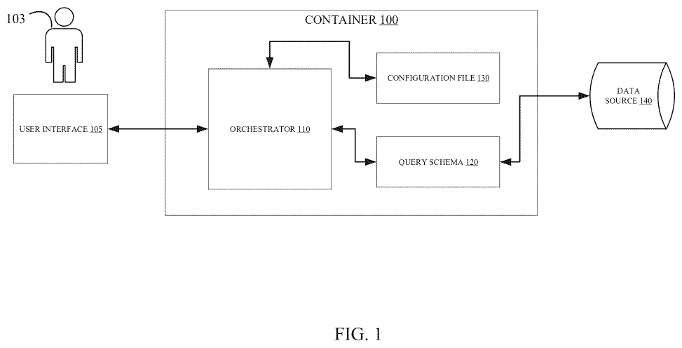

FIG. 1 is an illustration of example computing components related to generating APIs.

A user 103 may interact with a user environment via a user interface 105. User 103 may provide a query to the user interface, and based on the query, information may be extracted from data source 140. A user environment may be a software application platform operated by user 103.

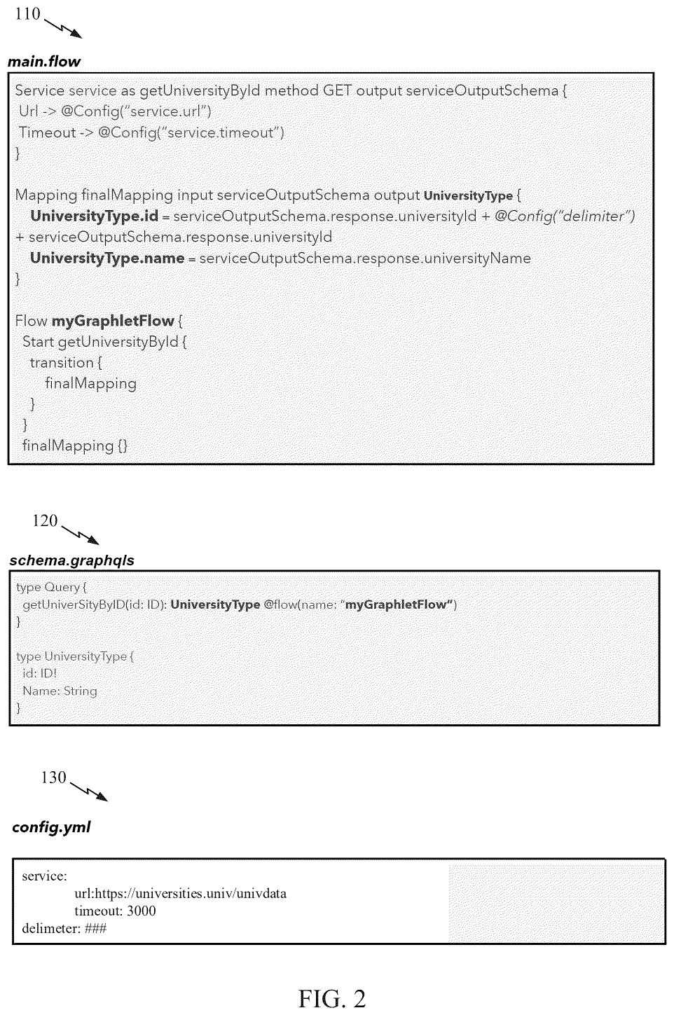

A container 100 may be provided with orchestrators 110, query schemas 120, and configuration files 130, which are discussed in further detail below with respect to FIG. 2. Container 100 may be a program associated with the user environment that is configured to receive, decompress, and/or execute files. By processing orchestrators 110, query schemas 120, and configuration files 130, container 100 allows for exposing an API that is based on the query schema 120, as discussed in further detail below.

Orchestrator 110 may be an executable file that is configured to extract information from query schema 120 based on requests from users 103. A function within orchestrator 110 may reference a particular node of query schema 120. In some embodiments, orchestrator contains API logic such as commands, structures for entering queries, methods for indicating which function within orchestrator 110 to call, and/or the like. For example, orchestrator 110 may contain a function for retrieving information from a node of query schema 120 and orchestrator 110 may also define a command that calls the function. In alternate embodiments, API logic such as commands, structures for entering queries, methods for indicating which function within orchestrator 110 to call, and/or the like is contained elsewhere within the user environment, and when orchestrator 110 is executed, logic within orchestrator 110 is integrated into the API logic. For example, orchestrator 110 may contain a function for retrieving information from a node of query schema 120 and a command that calls the function may be defined elsewhere within the user environment. In certain embodiments, one or more additional orchestrators are provided to container 100, and container adds the logic of these orchestrators to the API.

As discussed in further detail below with respect to FIG. 2, orchestrator 110 may be written in a domain specific language that is configured for extracting information from query schema 120. Orchestrator 110 may be stored in a compressed file format such as a zip file. When orchestrator 110 is provided to container 100, container 100 may decompress orchestrator 110 from the compressed file and execute orchestrator 110. In some embodiments, the language of the orchestrator 110 may be a declarative language. Orchestrator 110 may be constructed in such a way that orchestrator 110 is configured to be understood and used by the user environment. For example, orchestrator 110 may be written in a language with which the user environment is natively compatible. Thus, the user environment may use orchestrator 110 to perform queries based on query schema 120 even in scenarios when the user environment is not natively configured to interact with query schema 120.

A query from a user 103 may contain an indication that a function within orchestrator 110 should be called. For example, this indication may be based on a user 103 entering a command associated with the function, Based on this query, the function may be called by a processor associated with the user environment. Upon being called, the function within orchestrator 110 may extract information from a data source based on query schema 120. For example, the function within orchestrator 110 may extract information indicated in a particular node of query schema 120 from the data source to which query schema 120 corresponds. The orchestrator 110 may achieve this extraction because orchestrator 110 contains a reference to the node of query schema 120, discussed in further detail below with respect to FIG. 2.

The information within query schema 120, such as information indicated by a node of query schema 120, may be information from data source 140. Query schema 120 may indicate information from data source 140 because query schema 120 is constructed such that a node within query schema 120 references a location within data source 140 that stores particular information (e.g., a node of query schema 120 may be configured to return information from the location within data source 140 when called). When a function within orchestrator 110 is called, information from a particular location within data source 140 may be extracted based on the function extracting information that is referenced by the query schema 120.

As discussed in further detail below with respect to FIG. 2, query schema 120 may be written in a domain specific query language. In certain embodiments, query schema 120 is stored in a compressed file format such as a zip file. When query schema 120 is provided to container 100, container 100 may decompress query schema 120 from the compressed file and orchestrator 110 may extract information from query schema 120. In some embodiments, the language of the query schema 120 may be a declarative language. An example of a declarative domain specific query language that may be used for constructing query schema 120 is GraphQL. Query schema 120 may be constructed in such a way that it is not natively compatible with the user environment. For example, query schema 120 may be written in a language that is not natively compatible with the user environment. However, because orchestrator 110 is compatible with both the user environment and query schema 120, the user environment may perform queries based on the query schema by using orchestrator 110. In certain embodiments, one or more additional query schemas are provided to container 100, and container 100 decompresses these query schemas and allows for orchestrators to perform queries based on the additional query schemas.

In some embodiments, orchestrator is further configured to extract information from a configuration file 130. A configuration file 130 is generally any file other than an orchestrator or a schema file that is used to configure the API. Configuration file 130 may also be written in a compressed file format. In certain embodiments, configuration file 130 is provided to container 100. Container may decompress configuration file 130 from a zip file, and orchestrator 110 may then extract information from configuration file 130. This extraction may be achieved based on a function within orchestrator 110 that references configuration file 130 being called.

As discussed in further detail below with respect to FIG. 2, configuration file 130 may contain a reference to a data source 140 that is referenced by query schema 120. The reference to the data source 140 may be, for example, a link that leads to the data source 140. Orchestrator 110 may access the data source 140 and perform queries for extracting information from the data source 140 based on the query schema 120.

### Example Orchestrator, Query Schema, and Configuration File Used to Generate APIs

FIG. 2 is an illustration of example of an orchestrator, a query schema, and a configuration file used to generate APIs.

In some embodiments, an orchestrator may be written in a declarative domain specific language such as Flow, such as orchestrator 110 shown in FIG. 2.

The first node of orchestrator 110 contains a reference to configuration file 130. Configuration file 130 contains a reference to a data source. In this example, the data source is a list of universities. The reference to the data source in this example is a uniform resource locator (URL) link to the data source. The first node of orchestrator 110 also contains a reference to a node within query schema 120 that references the data source. The node within query schema 120, getUniversityById, references a particular location within the data source, as explained in further detail below. By extracting this URL from configuration file 130 and referencing this node within query schema 120, orchestrator 110 may access the data source and perform queries based on query schema 120.

The second node of orchestrator 110 contains a function that maps the information referenced by query schema 120 to a variable that is compatible with user environment. For example, the variable may be written in a language that is compatible with the language used by the user environment.

The third node of orchestrator 110 contains a function that calls the node within query schema 120. Calling this node, which references a location within data source, results in orchestrator 110 extracting information from the data source via query schema 120.

As mentioned above, the node within query schema 120 references a particular location within the data source. In this example, the location within the data source is a location corresponding to identifiers for universities. Thus, when this node within query schema 120 is called, identifiers for universities contained within the data source may be returned.

Example Operations Related to Generating APIs

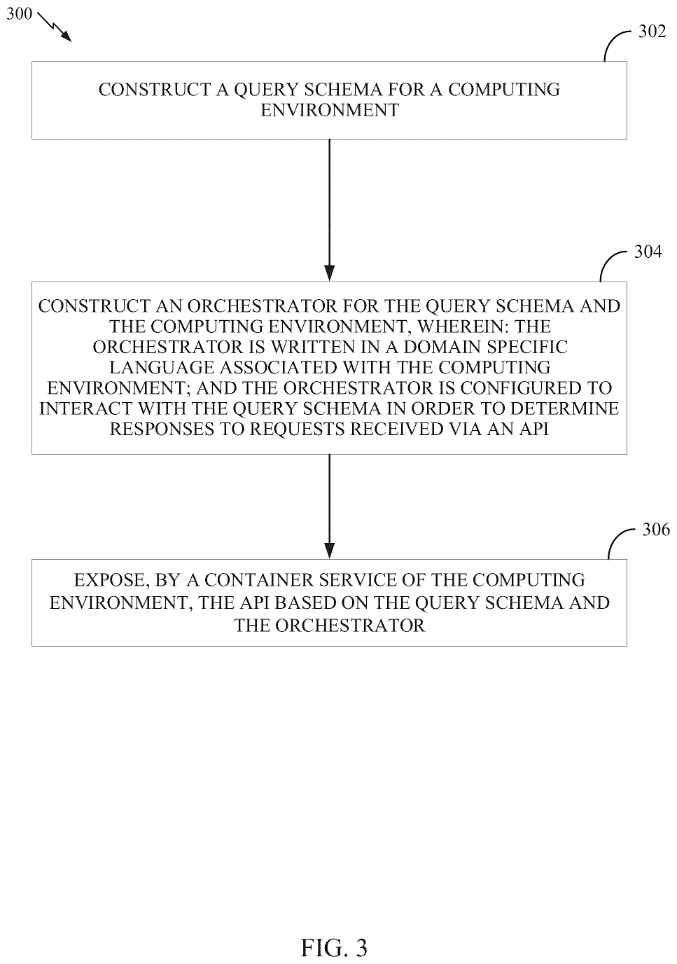

FIG. 3 depicts example operations 300 related to generating APIs. For example, operations 300 may be performed by one or more of the components described in FIG. 1.

Operations 300 begin at step 302 with constructing a query schema for a computing environment. In some embodiments, the query schema is stored in a compressed file format. According to certain embodiments, the query schema is based on a declarative language.

Operations 300 continue at step 304 with constructing an orchestrator for the query schema and the computing environment, wherein: the orchestrator is written in a domain specific language associated with the computing environment; and the orchestrator is configured to interact with the query schema in order to determine responses to requests received via an API. Certain embodiments provide that interacting with the query schema comprises extracting information from the query schema based on a request received via the API. In some embodiments, the request references a function associated with the orchestrator. According to certain embodiments, the extracting of the information from the query schema is based on the function including logic that references the query schema. In certain embodiments, the orchestrator is constructed in a compressed file format. Certain embodiments provide that the domain specific language is a declarative language.

Operations 300 continue at step 306 with exposing, by a container service of the computing environment, the API based on the query schema and the orchestrator. In other words, users may submit requests, and the orchestrator may extract information from the query schema based on these requests. For example, the API may expose a function within orchestrator, users may request information from the query schema by using this function, and the function may extract information from the query schema. In some embodiments, the orchestrator includes logic for extracting information from the query schema in the form of a function that is exposed via the API, and, when the function is invoked via an API request to extract particular information, the logic within the orchestrator is executed in order to extract the particular information from the query schema. Some embodiments provide that the container service comprises a file executor that is configured to expose the API based on decompressing the query schema and the orchestrator. In certain embodiments, the container service is configured to automatically update the API based on receiving and decompressing an additional query schema or an additional orchestrator.

According to certain embodiments, one or more configuration files may be constructed and provided to the container service, and the orchestrator may be configured to use the configuration files to configure the API.

In certain embodiments, the orchestrator comprises logic for extracting information from the query schema in order to determine responses to requests received via an API. Some embodiments further comprise receiving, via the API, a request from a user for particular information and executing the logic of the orchestrator to extract the particular information from the query schema based on the request. Certain embodiments further comprise providing a response to the request based on the extracted particular information.

Some embodiments provide that a determination is made not to execute an orchestrator based on detecting an error in the query schema or the orchestrator.

### Example of a Processing System for Generating APIs

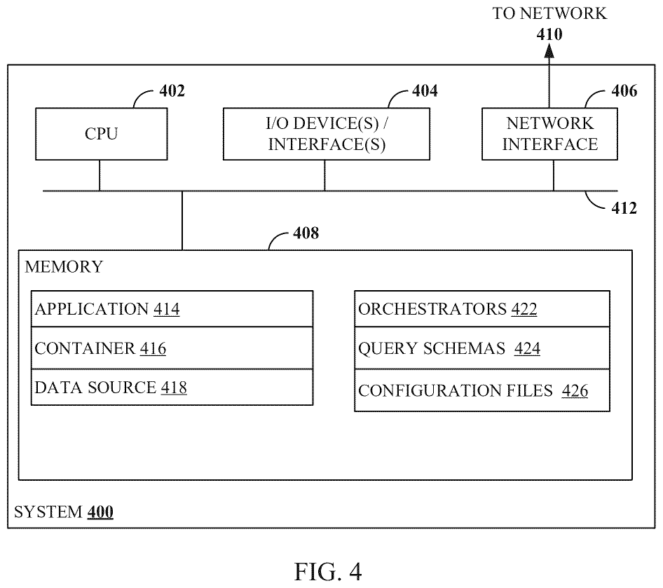

FIG. 4 illustrates an example system 400 with which embodiments of the present disclosure may be implemented. For example, system 400 may be configured to perform operations 300 of FIG. 3 and/or to implement one or more components as in FIG. 1.

System 400 includes a central processing unit (CPU) 402, one or more I/O device interfaces that may allow for the connection of various I/O devices 404 (e.g., keyboards, displays, mouse devices, pen input, etc.) to the system 400, network interface 406, a memory 408, and an interconnect 412. It is contemplated that one or more components of system 400 may be located remotely and accessed via a network 410. It is further contemplated that one or more components of system 400 may comprise physical components or virtualized components.

CPU 402 may retrieve and execute programming instructions stored in the memory 408. Similarly, the CPU 402 may retrieve and store application data residing in the memory 408. The interconnect 412 transmits programming instructions and application data, among the CPU 402, I/O device interface 404, network interface 406, and memory 408. CPU 402 is included to be representative of a single CPU, multiple CPUs, a single CPU having multiple processing cores, and other arrangements.

Additionally, the memory 408 is included to be representative of a random access memory or the like. In some embodiments, memory 408 may comprise a disk drive, solid state drive, or a collection of storage devices distributed across multiple storage systems. Although shown as a single unit, the memory 408 may be a combination of fixed and/or removable storage devices, such as fixed disc drives, removable memory cards or optical storage, network attached storage (NAS), or a storage area-network (SAN).

As shown, memory 408 includes application 414, container 416, and data source 418. In some embodiments, application 414 may be representative of a software application associated with a user environment. Container 416 may be representative container 100 of FIG. 1. Data source 418 may be representative of data source 140 of FIG. 1.

Memory 408 further comprises orchestrators 422, which may include orchestrator 110 of FIG. 1 and FIG. 2. Memory 408 further comprises query schemas 424, which may include query schema 120 of FIG. 1 and FIG. 2. Memory 408 further comprises configuration files 426, which may include configuration file 130 of FIG. 1 and FIG. 2. It is noted that in some embodiments, system 400 may interact with one or more external components, such as via network 410, in order to retrieve data and/or perform operations.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for application programming interface (API) generation comprising:
constructing a query schema for a computing environment;
constructing an orchestrator for the query schema and the computing environment, wherein:
the orchestrator is written in a domain specific language associated with the computing environment; and
the orchestrator is configured to interact with the query schema in order to determine responses to requests received via an API; and
exposing, by a container service of the computing environment, the API based on the query schema and the orchestrator.

2. The method of claim 1, further comprising constructing one or more configuration files and providing the configuration files to the container service, wherein the orchestrator is configured to use the configuration files to configure the API.

3. The method of claim 1, wherein interacting with the query schema comprises extracting information from the query schema based on a request received via the API.

4. The method of claim 3, wherein the request references a function associated with the orchestrator.

5. The method of claim 4, wherein the extracting of the information from the query schema is based on the function including logic that references the query schema.

6. The method of claim 1, wherein:
the query schema is constructed in a compressed file format;
the orchestrator is constructed in a compressed file format; and
the container service comprises a file executor that is configured to expose the API based on decompressing the query schema and the orchestrator.

7. The method of claim 6, wherein the container service is configured to automatically update the API based on receiving and decompressing an additional query schema or an additional orchestrator.

8. The method of claim 1, wherein the domain specific language is a declarative language.

9. The method of claim 1, wherein the query schema is based on a declarative language.

10. The method of claim 1, further comprising determining not to execute the orchestrator based on detecting an error in the query schema or the orchestrator.

11. A system for application programming interface (API) generation comprising:
one or more processors; and
a memory comprising instructions that, when executed by the one or more processors, cause the system to:
construct a query schema for a computing environment;
construct an orchestrator for the query schema and the computing environment, wherein:
the orchestrator is written in a domain specific language associated with the computing environment; and
the orchestrator is configured to interact with the query schema in order to determine responses to requests received via an API; and
expose, by a container service of the computing environment, the API based on the query schema and the orchestrator.

12. The system of claim 11, wherein the system is further configured to construct one or more configuration files and provide the configuration files to the container service, wherein the orchestrator is configured to use the configuration files to configure the API.

13. The system of claim 11, wherein interacting with the query schema comprises extracting information from the query schema based on a request received via the API.

14. The system of claim 13, wherein the request references a function associated with the orchestrator.

15. The system of claim 14, wherein the extracting of the information from the query schema is based on the function including logic that references the query schema.

16. The system of claim 11, wherein:
the query schema is constructed in a compressed file format;
the orchestrator is constructed in a compressed file format; and
the container service comprises a file executor that is configured to expose the API based on decompressing the query schema and the orchestrator.

17. The system of claim 16, wherein the container service is configured to automatically update the API based on receiving and decompressing an additional query schema or an additional orchestrator.

18. The system of claim 11, wherein the domain specific language is a declarative language.

19. The system of claim 11, wherein the query schema is based on a declarative language.

20. A method for application programming interface (API) generation comprising:
constructing a query schema for a computing environment;
constructing an orchestrator for the query schema and the computing environment, wherein:
the orchestrator is written in a domain specific language associated with the computing environment; and
the orchestrator comprises logic for extracting information from the query schema in order to determine responses to requests received via an API;
exposing, by a container service of the computing environment, the API based on the query schema and the orchestrator;
receiving, via the API, a request from a user for particular information;
executing the logic of the orchestrator to extract the particular information from the query schema based on the request; and
providing a response to the request based on the extracted particular information.
